(19) United States
(12) Patent Application Publication
(10) Pub. No.: US 2007/0028208 A1
(43) Pub. Date: Feb. 1, 2007

(54) Runtime generative programming method and system

(76) Inventor: Alec Maki, Monmouth, OR (US)

Correspondence Address: STITES & HARBISON PLLC, 1199 NORTH FAIRFAX STREET, SUITE 900, ALEXANDRIA, VA, 22314, US

(21) Appl. No.: 11/448,130

(22) Filed: Jun. 7, 2006

Related U.S. Application Data
(60) Provisional application No. 60/688,206, filed on Jun. 7, 2005.

(51) Int. Cl. G06F 9/44

(52) U.S. Cl. 717/106

(57) ABSTRACT

A real time code generator which automates the manufacture of software components and software systems based on a method for the runtime configuration and generation of text documents and software components. The text documents and software components are automatically generated within a defined domain through the use of generative tools. Advantageously, the automation and generation occurs at runtime such that the generative system senses changes to domain-specific configuration requirements and, in response, generates a fully executable runtime solution. The present method enables generative software development to occur during runtime, resulting in the automatic generation of compiled software components that can be deployed within a CBSE environment to create a product or system variant.

### CROSS REFERENCE TO RELATED APPLICATIONS

This application claims benefit of U.S. Provisional Application No. 60/688,206, filed Jun. 7, 2005 (which is hereby incorporated by reference).

### FIELD OF THE INVENTION

The present invention relates generally to computer system code generation for software engineering, and more specifically to a method and system for automating the manufacture of software components and software systems based on a method for the runtime configuration and generation of text documents and software components.

### BACKGROUND OF THE INVENTION

As the field of software development matures, the movement towards automating the software development process has gained momentum. One area of growing interest is the field of generative software development (GSD), which is typically defined by those of ordinary skill as “a software development paradigm based on modeling software system families such that, given a particular requirement specification, a highly customized and optimized intermediate or end-product can be automatically manufactured on demand from elementary, reusable implementation components by means of configuration knowledge”. GSD is a paradigm that seeks to automate the software development process, such that software products can be manufactured out of components, akin to how other industries have produced consumer, mechanical, electrical, and other goods for decades.

Historically, the focus of software engineering has been aimed at delivering solutions to specific problems. Hence, the dominant methods and tools for software engineering have been designed for developing single software systems. Methods such as object-oriented programming (OOP), model-driven architecture (MDA), object-relational mapping (ORM), and code generators have been used to combat the growing complexity and scope of single software systems. Utilizing these techniques, software developers have resources available that enable tremendous productivity. Even with a boon in productivity, however, developers have struggled to meet expectations.

In recent years, the importance of, and reliance upon software has grown. There has been an increasing demand for new systems and variants of old systems. The rate of change, variation, and complexity of requirements of software systems has increased. Hence, even with enhanced productivity software engineering has been unable to close the gap between supply and demand.

In an effort to solve these issues, the concept of software reuse has proliferated throughout industry. Historically, the trend of reuse has moved from the low-level (e.g., reusing methods) to the more abstract (e.g., reusing objects in OOP). The paradigms of component-based software engineering (CBSE) and service-oriented architecture (SOA) represent the latest movements with respect to software reuse. These paradigms shift away from more traditional approaches of software engineering where solution components are tightly coupled or integrated, limiting the ability for rapid change. Components in CBSE and services in SOA are units of software with well-defined interfaces, or standard ways of communicating. A component-based system is comprised of one or more components which themselves may be comprised of sub-components. Components communicate via interfaces, thereby enabling the system to function as a whole. Reusing components from one system to the next, however, becomes problematic when system architectures are not congruent. Components in both architectures may share much of the same functionality, yet differ enough to make reuse impossible. In SOA, this challenge exists as well. Although CBSE and SOA provide solutions to software reuse, they are limited in solving the demands of software engineers with regard to the increasing rate of change, system variations, and requirement complexity faced by the software industry.

Within the context of domain engineering, the paradigm of GSD strives to overcome the limitations of traditional software engineering. A domain is defined as a set of software systems and features that, as a whole, can be considered a family. Domain scope is defined in terms of technical, marketing, and economic requirements. Domain engineering involves domain analysis, in which a domain scope is established (i.e., a family of systems with common and variable features and dependencies between the variable features); domain design whose purpose is to develop a common architecture for a system family; and domain implementation which involves implementing domain components, generators, and the reuse infrastructure.

The paradigm of GSD focuses on domain implementation, such that systems or components may be automatically generated from domain-specific knowledge supplied by domain analysis and design. GSD strives to enable this automation by defining a problem space, configuration knowledge, and a solution space. The problem space is focused on the problem domain. The problem space is a set of domain-specific abstractions that enable engineers to communicate in a way natural to define the domain. The problem space contains the components available to define a domain and all their various combinations of systems. The solution space represents a specific solution implemented via domain specifications. Configuration knowledge, which is domain-specific, maps the correct combination of components and features from the problem space to the solution space. In the context of GSD, generative tools such as code generators are ideally used to apply domain-specific configuration knowledge and automate the production of components within a solution space. In practice, however, prior art code generators provide such automation only on a small scale (i.e., at the solution level) and are not extensible to a family of solutions such as a domain.

Whereas conventional software engineering strives to satisfy the requirements for a single system, domain engineering strives to provide reusable components and solutions for families of systems within a problem domain. A domain is often considered a product line, and domain engineering product-line development. In this context, a product line is a family of systems.

Variability and the rate of change in requirements is a core concern with respect to product lines and product families. The ability to generate diverse systems from a common domain requires effective management and realization of variations. Degree of variability measures the capability to support changes in a system. A low degree of variability indicates a rigid system, while a high degree of variability indicates a more nimble system. Variations between products in a product line can be determined throughout the software lifecycle, which typically includes requirements definition, analysis, design, implementation, compilation, linking, installation, and execution. Nimbleness is achieved by a software development process where variations are acted upon late in this software lifecycle. The later a variation is acted upon, the more nimble the system becomes. Given the demand on software engineering to satisfy the requirements of increasing software variations and a higher rate of change, a push in industry has been to define system variations as far back in the software lifecycle as possible.

Domain engineering is a paradigm that seeks to exploit commonalities among a family of systems while managing the variations among them in a systematic way. Applied to product-line engineering, this paradigm strives to create new product variants based on a common set of reusable assets such as a common architecture, components, models, and an effective development processes. These reusable assets may be deployed within the context of CBSE or SOA, thus enabling reuse within a domain. By applying the paradigm of GSD, reconfigured components can be manufactured based on domain-specific configuration information, where the configuration information serves to configure the variation points in a system.

Code generation is one enabling technology that makes GSD such a powerful technique. Only by implementing domain-specific configuration knowledge through generators can the full potential of GSD be truly realized. Unfortunately, prior art for code generation has been limited to single system engineering and thus, using code generation to build specific systems to solve specific problems. As a result, prior methods and techniques used in GSD provide limited solutions in terms of software components which are generated and limited flexibility or variance in those generated components.

One commonly used prior art technique is template-based code generation. Software developers commonly utilize template-based code generation to automate development tasks for single system engineering, thereby improving efficiencies through the elimination of redundancies and reduction in time needed for code maintenance at an application level.

FIG. 1 illustrates the usage of template-based code generators. A code generator 100 has a code generation engine 102 that accepts and processes input. For a template-based code generator, a template-based generator 104 and static configuration are used to generate text documents, such as XML, SQL, source code, etc. A template is passed through a code generator, in combination with static configuration information, to produce an output text document. The processing itself generally consists of replacing specific sequences of text with data that represents how the text output needs to be configured. Some template-based generators allow complete code blocks to be embedded into a template, enabling powerful transformation capabilities. Configuration information typically comes from user-provided input or from files. Therefore, the conventional generative process is characterized by a generation strategy that occurs during or before compilation, when source code files are assembled into a machine readable language or byte code.

Prior art template-based code generators do not enable a GSD strategy that can be fully automated at runtime to generate software components and software systems for any solution within a given domain. They are not designed for the automatic manufacturing of software components and systems for any family of systems within any given domain. They are limited with respect to both the runtime generation of compiled software components and the acceptance of runtime configuration information. With this in mind, prior art template-based code generators are limited in that they define variations in a system only during or before compilation in the software lifecycle. A related limitation is that template-based code generators produce an intermediate product, such as source code, and not an end product, such as fully realized components that can be used to assemble systems. Still another limitation is that prior art template-based code generators have no expectation of domain-specific configuration information. Input comes in the form of text documents and text files with no guarantee of domain-specificity.

Accordingly, there is a need in the art for improved methods for generated software components.

### SUMMARY OF THE INVENTION

The present invention is directed to a real time code generator which automates the manufacture of software components and software systems based on a method for the runtime configuration and generation of text documents and software components. This is accomplished, in part by, utilizing domain engineering, in which a GSD paradigm is applied to domain implementation. As a result, software components and software systems are automatically generated within the domain through the use of generative tools. Advantageously, the automation and generation occurs at runtime such that the generative system senses changes to domain-specific configuration requirements and, in response, generates a fully executable runtime solution. The present invention enables the paradigm of GSD such that generative software development can occur during runtime, resulting in the automatic generation of compiled software components that can be deployed within a CBSE environment to create a product or system variant.

One object of the present invention is to provide a runtime generative engine in memory for the runtime generation of text documents and source code files.

Another object of the present invention is to enable runtime configuration of the generation process wherein configuration information is provided through one or more domain-specific programmatic interfaces.

Yet another object of the present invention is to create at runtime a generator in memory which has the domain-specific programmatic interfaces needed for accepting configuration information at runtime.

Still another object of the present invention is to provide a mechanism for asynchronous communication with services external to the runtime generative engine.

Yet another object of the present invention is to provide a means for the runtime compilation of generated source files such that a compiled software component, or dynamic link library (DLL), is created.

Still another object of the present invention is to provide a mechanism wherein said compiled software components implement well-defined, loosely-coupled interfaces such that they may be deployed within a CBSE or SOA environment.

Yet another object of the present invention is to provide a means for the runtime generative engine to accept and process families of exemplars, wherein a family has logical relationships such that child exemplars may be referenced by parent exemplars, and wherein the output of an exemplar is configured via domain-specific programmatic interfaces.

To achieve the foregoing objectives, in one form of the present invention, a computer environment is provided with means for enabling runtime generative software development (GSD) which uses a method for the runtime configuration and generation of text documents, source files, and software components based on domain-specific configuration knowledge provided at runtime.

In one embodiment of the present invention, one or more exemplars are passed into the runtime generative engine from an external software system. An exemplar is a family of computer documents written in computer coding language that is logically interrelated. As implemented in the present invention, exemplars control the generative process.

It is important to stress the distinction between exemplars used in the present invention and templates used in the template-based code generators of the prior art. The present exemplars have different types, wherein each type of exemplar has a purpose specific to the generative process. On the other hand, prior art templates have only one function or purpose: they are text templates for the output text to be generated.

In the present invention, one type of exemplar, text exemplars, share the most similarity to prior art templates in that text exemplars generate text documents, such as XML, SQL, code fragments, etc. However, text exemplars differ from prior art templates in that text exemplars may reference one or more configuration exemplars. A configuration exemplar is a special type of text exemplar that defines the implementation of a domain-specific programmatic interface used to configure its associated text exemplar. This programmatic interface provides a contract between the generator and external systems that function to sense changes in configuration information for accepting domain-specific configuration information.

It will be apparent to one of ordinary skill in the art that using text exemplars which reference configuration exemplars allows for much more flexibility in the generative process that what a prior art template achieves in template-based code generation systems which only reference static information.

Further flexibility of the present invention is provided by text exemplars referencing other text exemplars, e.g. a parent text exemplar may contain or reference one or more child text exemplars, each with their own respective configuration or child text exemplars. Within the context of the current invention, a family of exemplars is said to comprise a parent exemplar, its referenced exemplars, and all their respective descendents.

Software exemplars and text exemplars comprise the two major categories of exemplars in terms of form and functionality. Software exemplars are structural in nature and, as such, serve to define the structure of various aspects of software. A software exemplar can be broken into three sub-classifications: solution, component, and code. A solution exemplar defines the structure of a software solution in terms of its components. A component exemplar defines the structure of a software component in terms of its code constructs, such as classes, interfaces, and enumerations among others. A code exemplar defines the structure of a code construct, which can be defined within the context of this document as a basic unit of software code within an object-oriented language. A code exemplar has a type that corresponds to its type of code construct. For example, a class exemplar is a special type of code exemplar that corresponds to a class in source code.

Text exemplars are content-oriented in nature. Whereas software exemplars define structure of software constructs, text exemplars provide the body to fill in the structure. In this regard, a content exemplar, which is a special type of text exemplar, provides the output of a code exemplar with content. This content varies according to the type of code exemplar. For example, a class exemplar uses a content exemplar to provide member, method, and property definitions for its generated class. An implementation exemplar is a special type of text exemplar that defines the implementation of an interface for a class which, in turn, is defined by a class exemplar. The use of implementation exemplars ensure generated software components can communicate via well-defined interfaces and be deployed within a CBSE or SOA environment.

Component exemplars can be logically related to a family of class and/or interface exemplars that, in combination with domain-specific configuration information, can be passed into the runtime generative engine and processed such that source code is generated for a software component. The runtime generative engine processes each class and interface exemplar specified by the component exemplar, generating the source code for its respective class or interface. After all class and interface exemplars have been processed, the source code for the component is available for deployment.

When multiple components are being constructed within one system, one generated component may depend on another generated component. In such a case, a meta-exemplar is used to generate software exemplars with up-to-date dependency information. A meta-exemplar is a special type of text exemplar that generates other exemplars. After a solution has been generated, the runtime generative engine may deliver the generated source code in memory, as files, or as compiled components.

To generate a text document from a text exemplar, the runtime generative engine generates a compiled software component in memory whose purpose is to generate text. In other words, a custom generator is produced by the runtime generative engine for each text exemplar. The custom generator implements domain-specific programmatic interfaces defined by the configuration exemplars of the text exemplar. The custom generator receives domain-specific configuration information from external services that have knowledge of the domain-specific programmatic interface. Based on a specific configuration, supplied during runtime via the programmatic interface, an output text document is generated.

In one embodiment of the invention, the runtime generative engine provides a programmatic interface for interaction with external services that may include other instances of a runtime generative engine. The programmatic interface includes a means for external services to send a generative request, along with the appropriate parameters, to the runtime generative engine. The programmatic interface also includes a mechanism for asynchronous communication during the generation process. For example, external services may register to be notified of events occurring during generation.

### BRIEF DESCRIPTION OF THE DRAWINGS

FIG. 1 schematically illustrates prior art code generation via template-based code generators.

FIG. 2 schematically illustrates an overview of a runtime generative software development environment where a component or solution can be manufactured based on a runtime generative request according to an embodiment of the present invention; and FIG. 2′ illustrates in greater detail the ememplar family depicted in FIG. 2.

FIG. 3 schematically illustrates an example of the logical relationship of a family of exemplars that could be used generate a software solution in accordance with the present invention.

FIG. 4 schematically illustrates an overview of how processes interact with one another within the runtime generative engine according to an embodiment of the present invention.

FIG. 5 schematically illustrates the solution builder process in an embodiment of the present invention.

FIG. 6 schematically illustrates the component builder process in an embodiment of the present invention.

FIG. 7 schematically illustrates a process flow diagram for a component builder used to generate a component in an embodiment of the present invention.

FIG. 8 schematically illustrates an overview of the data flow for the code generation process according to one embodiment of the invention.

FIG. 9 is a schematic block diagram that indicates important modules for a code generator according to one embodiment of the invention.

FIG. 10 schematically illustrates a data flow diagram for the code generation process in accordance with a preferred embodiment of the invention.

FIG. 11 schematically illustrates a data flow diagram for the component compilation process used in a preferred embodiment of the invention.

FIG. 12 schematically illustrates an overview of the text generation process used in a preferred embodiment of the present invention.

FIG. 13 schematically illustrates an overview of the entities used by a text generator in a preferred embodiment of the invention.

FIG. 14 schematically illustrates a data flow diagram for a text generator according to a preferred embodiment of the present invention.

FIG. 15 a schematic illustration of the runtime generation process of a custom generator component is shown in accordance with a preferred embodiment of the present invention.

FIG. 16 schematically illustrates the process of text generation within a runtime generative software development environment in accordance with the present invention.

FIG. 17 schematically illustrates the family of exemplars for the custom generator used to generate a text document in a preferred embodiment of the invention.

FIG. 18 schematically illustrates an example of the source code generated for a custom generator according to a preferred embodiment of the present invention.

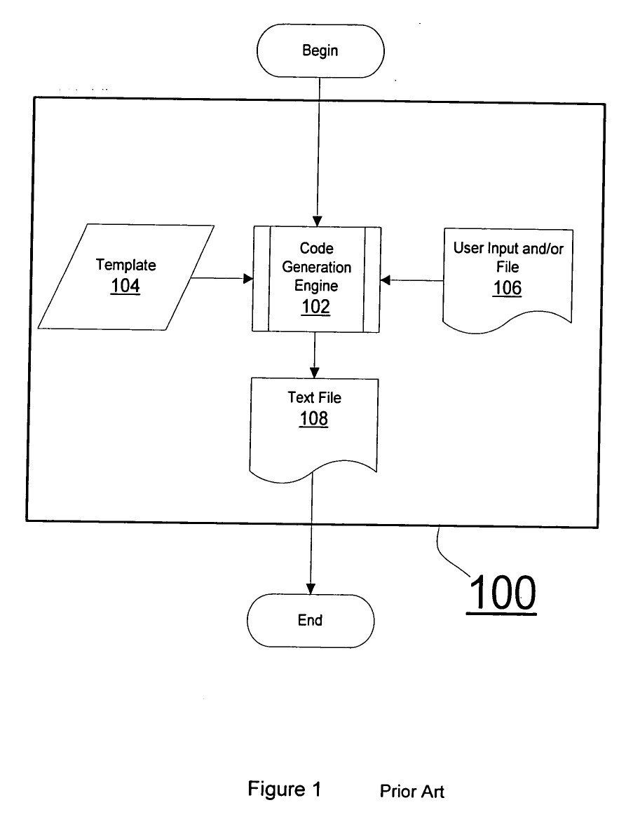

### DETAILED DESCRIPTION OF THE INVENTION

An embodiment of the present invention relates to a method for the runtime configuration and generation of text documents and software components.

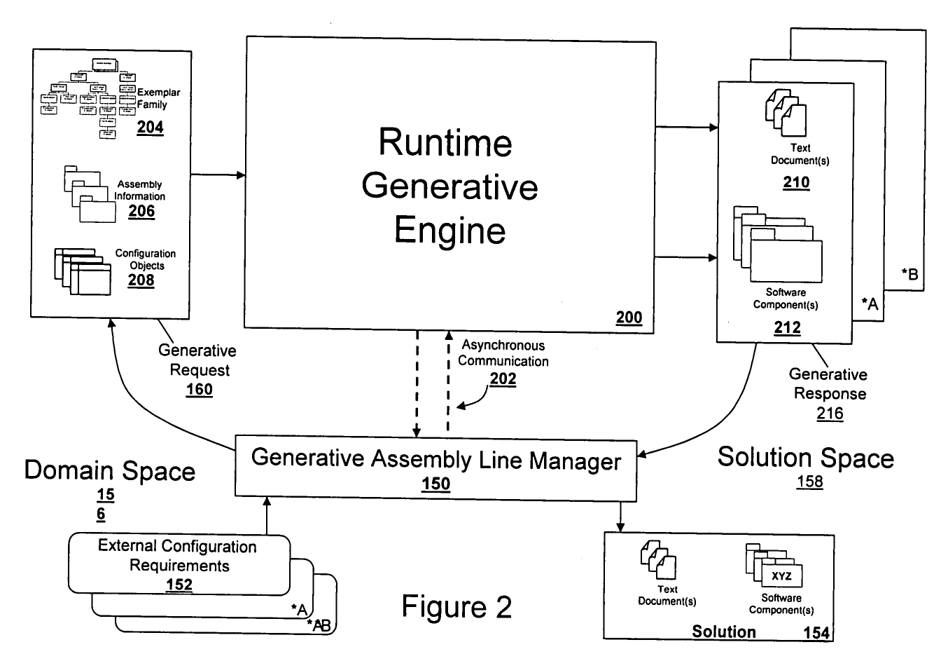

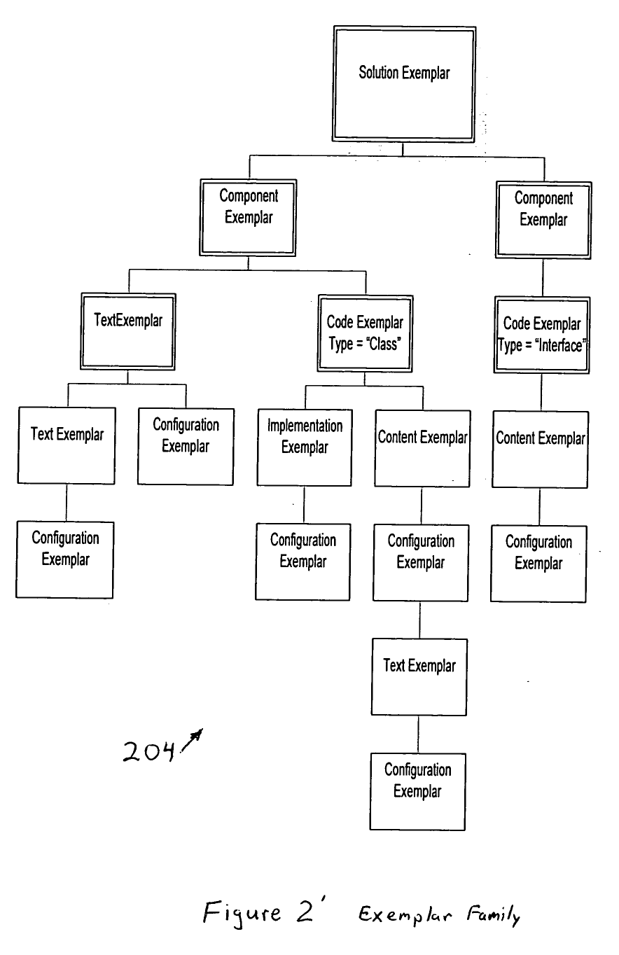

FIG. 2 schematically illustrates an overview of a runtime generative software development environment where a component or solution can be manufactured based on a runtime generative request according to an embodiment of the present invention; and FIG. 2′ illustrates in greater detail the ememplar family depicted in FIG. 2. Unique aspects of the invention are characterized by runtime input from a domain space (e.g., a family of exemplars 204, assembly information 206, and domain-specific configuration objects 208); the runtime generative engine 200; asynchronous communication 202 between the runtime generative engine 200 and external systems; and the generation of text documents 210 (e.g., XML, SQL, etc.) and software components 212 that map to a system within a solution space.

More specifically, a system external to the runtime generative engine 200 (e.g., a generative assembly line manager 150) detects changes to system configuration requirements 152 for a given domain, where said system exists within a family of systems in a domain. The system external to the runtime generative engine 200 may operate on a different computing system than that of the runtime generative engine 200, such that both operate in a distributed computing environment (e.g., in an enterprise setting). The generative assembly line manager 150 determines the software components required to effect the appropriate changes for a solution and, accordingly, constructs a generative request 160. This is done by translating the detected changes into domain-specific configuration objects 208, providing assembly information 206 for the required component (e.g., version information, assembly dependencies, assembly name, security information, etc.), and providing a family of exemplars 204 necessary for generating a software component(s) 212 and related text documents 210 (e.g., XML, SQL, etc.). This generative request 160 is sent to the runtime generative engine 200.

The runtime generative engine 200 processes a family of exemplars 204 and configuration objects 208 to generate text documents 210 and software components 212. This generation process may not be synchronous. For example, the runtime generative engine 200 may discover that it requires more information (e.g., another exemplar for the family of exemplars 204, more assembly information 206, or another configuration object 208) and request this information from an external system (e.g., a generative assembly line manager 150). The generation process may wait for a response from the external system. In other words, the generative process may occur asynchronously depending on messages sent and received by the runtime generative engine 200. In one embodiment, this asynchronous communication 202 is a manifestation of service oriented architecture (SOA) industry standards such as Simple Object Access Protocol (SOAP) and the web services description language (WSDL). SOAP is an extensible markup language (XML) protocol used for communication between different services or systems. In this way, consistent with a preferred embodiment of the invention, the runtime generative engine 200 does not need to know a priori all necessary information from a generative request 160 to begin the generative process. This is a distinct feature of the present invention as compared to the prior art.

During runtime, the generative assembly line manager 150 sends a series of generative requests 160 to the runtime generative engine 200 which responds with a series of generative responses 162. Each such response includes a software solution consisting of one or more software components 212 and associated text documents 210. The generated solution of software components 212 is received by the generative assembly line manager 150 and deployed during runtime amongst any number of existing systems. In this way, the present invention enables runtime generative software development.

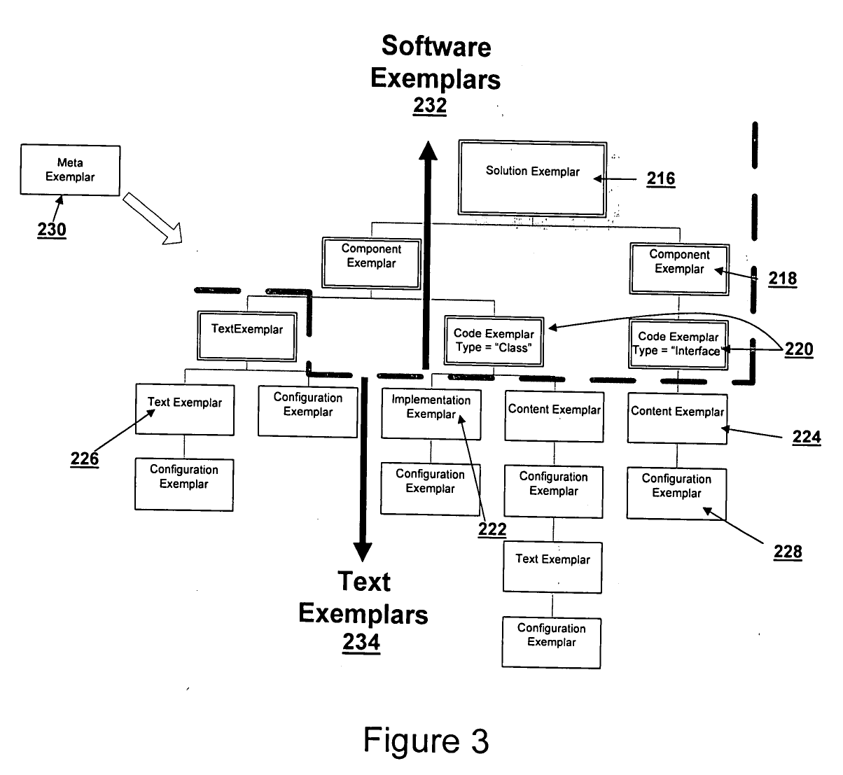

FIG. 3 schematically illustrates an example of the logical relationship of a family of exemplars that could be used generate a software solution in accordance with the present invention. A family of exemplars may be provided in a generative request 160 to the runtime generative engine 200. Each exemplar within a family is a text file on disk or in memory that provides specific instructions to guide the generative process. In an embodiment of the present invention, each classification of exemplar within a family has its own responsibilities within the generative process. Software exemplars and text exemplars comprise the two major categories of exemplars in terms of form and functionality. Software exemplars are structural in nature and, as such, serve to define the structure of various aspects of software. A software exemplar 232 can be broken into three sub-classifications: solution 216, component 218, and code 220. A code exemplar 220 defines the structure of a code construct, which can be defined within the context of this document as a basic unit of software code within an object-oriented language. A code exemplar 220 has a type that corresponds to its type of code construct. Hence, with respect to the C# programming language, there are five types of code exemplars: class, interface, struct, enum, and delegate. However, a code construct may be defined for any number of object-oriented languages. Besides structural information, a software exemplar 232 may contain processing information, in the form of processing directives. As will be described in detail later, these directives vary with the type of software exemplar to which they apply.

Text exemplars are content-oriented in nature. So whereas software exemplars define structure of software aspects, or constructs, text exemplars provide the body to fill in the structure. There are four five types of text exemplar: plain 226, implementation 222, content 224, and configuration 228 and meta 230. A plain text exemplar produces plain text documents, which may include any variety of textual output. Some examples include without limitation extensible markup language (XML), structured query language (SQL), hypertext markup language (HTML), and help documents. An implementation exemplar 222 associates with a class exemplar (i.e., a code exemplar with a “class” type). When the class exemplar is generated, its implementation exemplar 222 generates an implementation of an interface for that class. Within the body of the implementation exemplar 222 would be a processing directive similar to the following.
<#@implements=“[interface type]”#>

This processing directive specifies that its implementation exemplar 222 implements a certain type of interface, wherein the type is defined within an object-oriented programming language. A content exemplar 224 associates with any type of code exemplar 220, and provides basic software content. For example, a content exemplar may be referenced by an interface exemplar (i.e., a code exemplar with an “interface” type). In this case, the content exemplar 224 defines the content to be placed in the body of the interface declaration. This content may define the methods and properties which are exposed by the interface. A configuration exemplar 228 is referenced by any type of text exemplar. For its parent text exemplar, a configuration exemplar 228 provides the implementation for a programmatic interface. This interface is used to configure the generative process with respect to the parent text exemplar. There are two major classifications of exemplars: software and text.

During the course of generating a solution consisting of many components, dependencies may arise between components, especially between interfaces that may be generated at runtime. Before the generative process, however, there is no way to know how an interface would be configured to be generated. Therefore, this information must be acquired during the generative process. Without this information, it would be impossible to properly compile and, in some cases, configure the generation of various components. For example, a class exemplar may reference an implementation exemplar with a type of interface that is unknown until the interface is generated and compiled. In this case, the “implements” processing directive given as an example above would not suffice, since the type of interface to implement is generated and, therefore, unknown.

Accordingly, exemplars must make use of runtime information and change appropriately. In a preferred embodiment of the invention, exemplars may themselves be generated from special text exemplars. In this way, information unknown before the generative process began can be placed appropriately into processing directives to guide the generation of solutions comprising many components some of which depend on others.

By using a real-world example from the domain of market research, this process may be better understood. Within market research many types of analyses may be available for analyzing the same data set. Moreover, research analysts and/or statisticians may develop new analyses over the course of time. The development of these analyses typically happens through the development of algorithms in third-party tools, such as SAS and Matlab. To bring these new analyses into an enterprise setting, source code is written and sometimes modified across enterprise software systems and components to integrate with the new analysis.

Ideally, in a generative software development environment, a new analysis (e.g., chi-square) would be detected and the appropriate software systems and/or components appropriately generated to reflect the corresponding changes in configuration requirements. In this case, certain interfaces may share similar functionality but differ with respect to a particular analysis. Within the context of the present invention, the new chi-square analysis may be detected via a generative assembly line manager 150 and the appropriate generative request 160 sent to the runtime generative engine 200. Subsequently, a component may be generated that defines an IChiSquareAnalytic interface. Another component may expect to implement an interface with that functionality, but will not know about the IChiSquareAnalytic interface because it has just been generated. By treating exemplars as configurable at runtime, this can be solved. By revising the syntax of the “implements” processing directive, as follows, the proper type can be generated at runtime.
<#@implements=“${=Process(“IUnknownAnalytic.exemplar”)r}”#>

In this case, everything between the “${” and “}” brackets is analyzed through a meta-exemplar 230, which utilizes a IMetaProcessor interface. A meta-exemplar uses different delimiters than other exemplars since it must ignore the “<#” and “#>” brackets. The. The “IUnknownAnalytic.exemplar” refers to the interface exemplar which is used to create the IChiSquareAnalytic. The Process( ) method translates the interface exemplar file name into the string representation of the type it generated. The runtime generative engine stores The interface exemplar and the type it generates are stored in-memory during the course of the generation process, along with other exemplars and their corresponding types. When the interface exemplar is referenced as in this example, it is replaced with the generated type, which in this case is IChiSquareAnalytic After.
<@#implements=“IChiSquareAnalytic”#>

In a preferred embodiment of the present invention, a meta-exemplar is used to generate other exemplars at runtime as components are being generated that may depend on one another.

In FIG. 3, the parent of the exemplar family is a solution exemplar 216, which defines the structure of a software solution that contains one or more components. In an alternative embodiment, the parent of the exemplar family may be a component exemplar. A solution exemplar 216 references one or more component exemplars, and may contain processing directives to guide the solution generation process. A component exemplar 218 defines the structure of a software component 212 in terms of its source code representation (e.g., classes, interfaces, enumerations, structures, delegates) and affiliated text documents (e.g., XML, SQL, etc.). A component exemplar 218 contains references to code exemplars 220 and text exemplars 226. In addition, a component exemplar 218 may contain directives for guiding the component generation process. A code exemplar 220 defines the structure of first-order source code constructs, including as applied to the C# programming language, without limitation, classes, interfaces, enumerations, structures, and delegates. Alternatively, source code constructs may be defined for other programming languages including, without limitation, Java. For each type of construct, there is an associated type of code exemplar 220. A class exemplar, for example, is a special type of code exemplar 220 that defines the structure for a class in an object-oriented programming language. A code exemplar 220, if it is assigned a type of class, may reference zero or more implementation exemplars. An implementation exemplar 222 is a special type of text exemplar 226 that defines the implementation of an interface for a given class. A code exemplar 220 may reference a content exemplar as well. A content exemplar 224 is a special type of text exemplar 226 that defines content for a given code exemplar 220. For example, a class exemplar may use a content exemplar to define properties, variables, and methods. A text exemplar 226 defines the logic and structure for the generation of text documents 210.

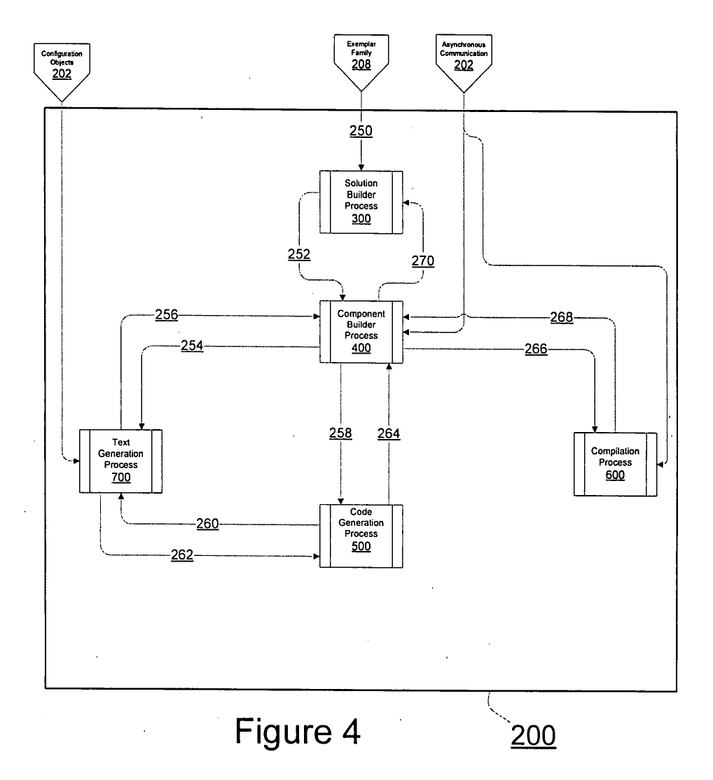

FIG. 4 schematically illustrates an overview of how processes interact with one another within the runtime generative engine according to an embodiment of the present invention. FIG. 4 also serves to illustrate how exemplars are processed within the runtime generative engine 200 according to their respective roles. In action 250, the parent exemplar of an exemplar family 204 is provided as input into the solution builder process 300. Generally, the parent exemplar is a solution exemplar 216. Alternatively, the parent is a component exemplar 218. The solution builder process 300 identifies component exemplars 218 within the family of exemplars 204. The solution builder process 300 determines component dependencies, based on assembly information 206. In the next action 252, the solution builder process 300 calls upon the component builder process 400 to assemble each component exemplar 218 in the proper order. During this process, each text exemplar 226 referenced by the component exemplar 218 is identified and, in the next step 254, passed to the text generation process 700. In a preferred embodiment of the present invention, the text generation process 700 calls the runtime generative engine 200 to generate a custom generator used to configure and produce the text document. The generation of the text document is configured via configuration objects 208 that may originate from a remote system, e.g., the generative assembly line manager 150.

In the next action 256, each text document is returned to the component builder process 400, which next 258 calls the code generation process 500 for each code exemplar 220 referenced by the component exemplar 218. As a rule, all child exemplars of a code exemplar are text exemplars. Hence, during this process, each child exemplar referenced by the code exemplar 220 is provided in the next action 260 to the text generation process 700 which returns 262 a text document representing a code fragment. The code generation process 500 places each code fragment within a body of source code according to the type of code exemplar 220 being processed. Once the code has been generated and constructed for a respective code exemplar 220, the code generation process 500 next 264 provides the source code file to the component builder process 400. After each code exemplar 220 has been processed and the corresponding source code files generated, the code generation process next 266 delivers all the source code generated for the component exemplar 218, along with corresponding assembly information 206, to the compilation process 600. The compilation process next 268 returns a compiled component which the component builder process then 270 returns to the solution builder process 300. Once all components have been generated and compiled in the same fashion, the solution builder process 300 next 272 outputs the generated text documents, source code files, and components to the runtime generative engine 200. In the next action 274, the runtime generative engine 200 delivers the proper generative response, which may or may not include source files.

As illustrated in FIG. 4, asynchronous communication 202 may occur at any point during the generative process. For example, an external system may send a message to cancel the processing of the generative request 160. In another example, the text generator 400 may realize that it requires another configuration object 208 to properly execute the generation of a text document. In this case, the text generator 400 stops generating, sends a message requesting the needed configuration object 208, and waits for a response. When a response message arrives, it may provide the requested configuration object 208, in which case the text generator 400 resumes the generation process. The response may indicate that the configuration object is unavailable, in which case the runtime generative engine 200 may terminate the generation process and provide a generative response 162 with an appropriate error message. In still another example, the runtime generative engine 200 may discover that an assembly reference (e.g., DLL) is required to properly compile the in-memory source files 234. A message requesting the appropriate assembly reference may be sent out to an external system. The runtime generative engine 200 waits until receiving the assembly reference in a response message before compiling. In this case, if a response indicates the assembly reference is unavailable, the runtime generative engine may cancel the compilation, and send a generative response 162 that includes generated source code files and other text documents with a descriptive error message.

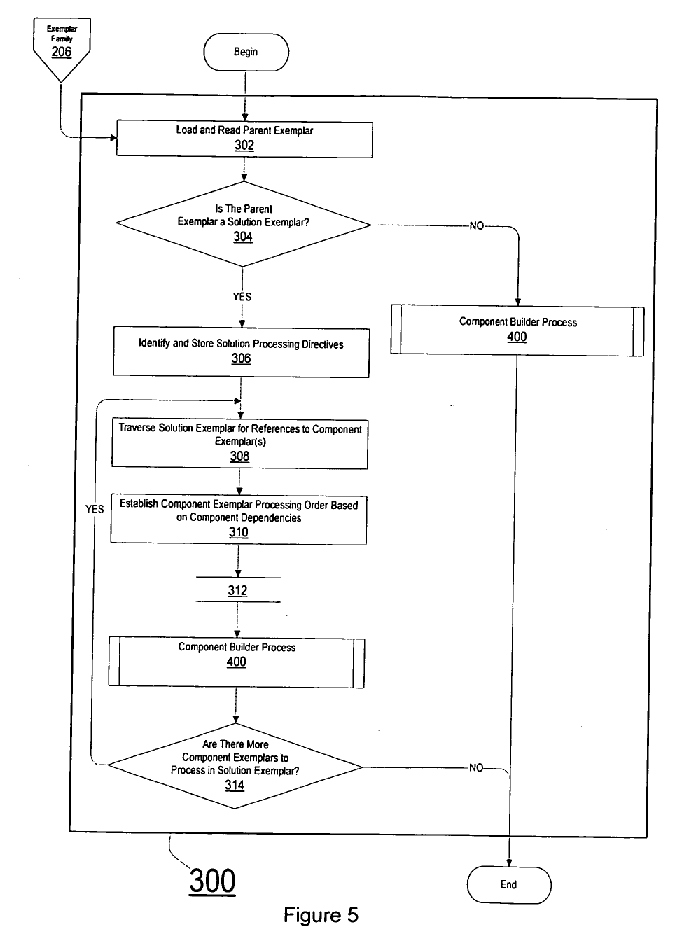

FIG. 5 schematically illustrates the solution builder process in an embodiment of the present invention. In the solution builder process 300, the first step 302 is to load and read the parent exemplar. A check 304 is made to determine whether the parent is a solution exemplar 216. If the check 304 results in NO, then the parent is a component exemplar 218 and the FLOW requires the component exemplar 218 be passed to the component builder process 400. If the check 304 results in a YES, then the parent exemplar is a solution exemplar 216 and the FLOW moves to the next step 306 in which processing directives in the solution exemplar 216 are identified and stored in memory. For each type of exemplar, processing directives are contained within “<#@” and “#>” delimiters. Processing directives typically vary from one type of exemplar to the next. In the case of solution exemplars, processing directives may include without limitation, naming conventions, default assembly versioning, etc. In the next step 308, the solution exemplar 216 is traversed to identify references to component exemplars. Based on assembly information 206 and/or processing directives, component dependencies amongst the components to be generated are determined 310. In this way, a proper order can be determined for generating the components. In step 312, components exemplars whose dependencies are satisfied may be generated in parallel. In one embodiment of the invention, a separate thread may be allocated to process each component exemplar 218, such that component exemplars may be processed in a simultaneous fashion. In the next operation, each component exemplar 218 is sent through the component builder process 400, the result of which may be any combination of text documents, source code files, and/or a compiled component. Next, a check 314 is made to determine if there are any more component exemplars referenced by the solution exemplar 216. If the result of the check is YES, then the next step 308 is to again traverse the parent exemplar for another referenced component exemplar 218.

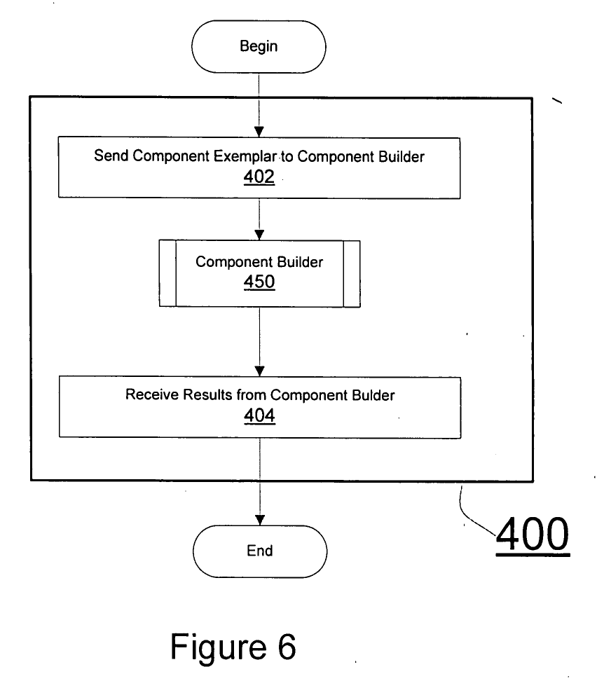

FIG. 6 schematically illustrates the component builder process in an embodiment of the present invention. In the component builder process 400, the first step is to send a component exemplar 218 to a component builder 450. The component builder 450 builds a component which is received in the next step 404.

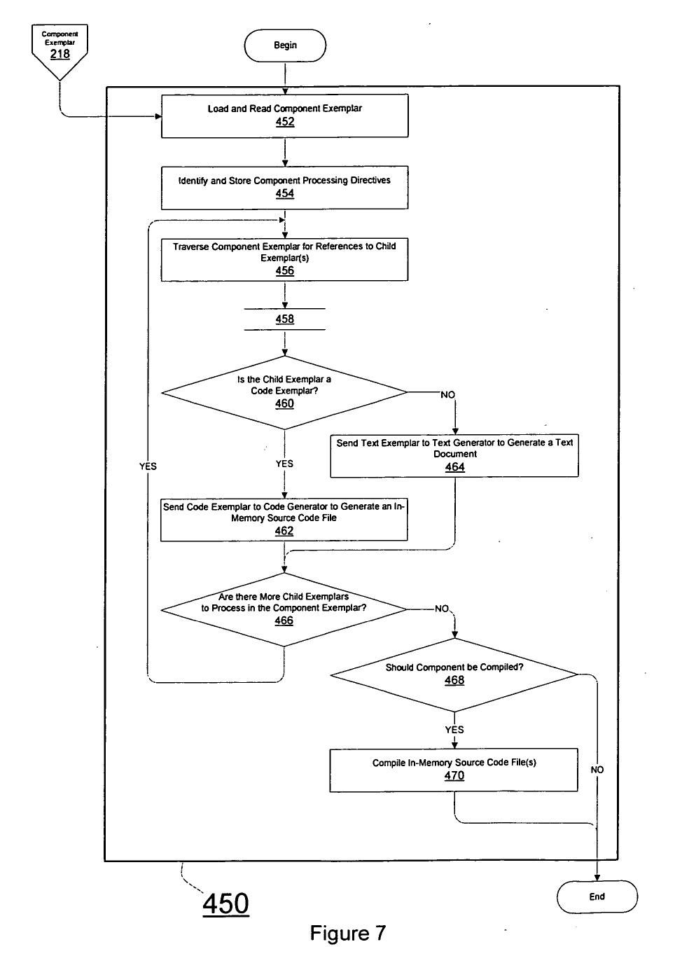

FIG. 7 schematically illustrates a process flow diagram for a component builder used to generate a component in an embodiment of the present invention. The component builder manages the generation of source code files 506, text documents 210, and/or a solution of compiled software component(s) 214. First 452, a component exemplar is loaded and read. In the next operation 454, component processing directives are identified and stored. A component processing directive may contain information including without limitation naming conventions, assembly conventions, etc. The next operation 456 consists of traversing the component exemplar and identifying references to child exemplars. In a preferred embodiment, each child exemplar referenced by the component exemplar 218 may processed on a distinct thread to be executed in parallel 458. A check is made 460 to determine if a child is a code exemplar 220. If the result of the check 460 is YES, then the child is a code exemplar and flow of operation proceeds to step 462, wherein the code exemplar is sent to the code generator to generate an in-memory source code file. If the result of the check is NO, then the child exemplar is a text exemplar and the FLOW of operation moves to step 464, wherein the text exemplar is provided to the text generator to produce a text document. In the next step, a check 466 is made to determine if the component exemplar has more child exemplars to process. If the check determines YES, then the FLOW of operation moves back to step 456 such that the next child exemplar may be identified. If the check 466 determines NO, then the FLOW of operation moves to step 468 which is a check to see if the compiled source code should be compiled. In this step, assembly information 206 and/or stored processing directives from step 454 are used to determine whether compilation should occur. If the result of the check 468 is YES, then the next step 470 is to compile the source files. If the result of the check is NO, then the component builder exits without compiling source code.

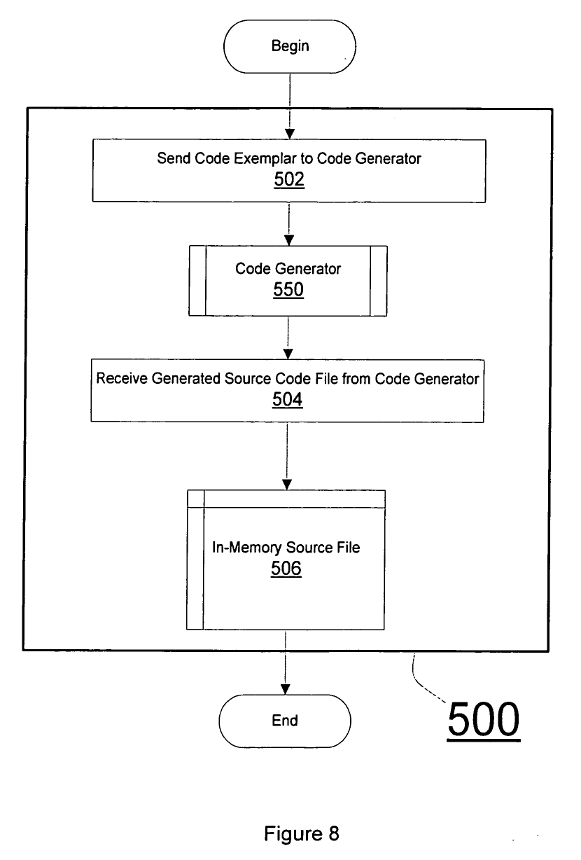

FIG. 8 schematically illustrates an overview of the data flow for the code generation process according to one embodiment of the invention. In the first step 502, the code exemplar is sent to the code generator 550. In step 504, generated source code is received from the code generator 550, resulting in in-memory source files 506.

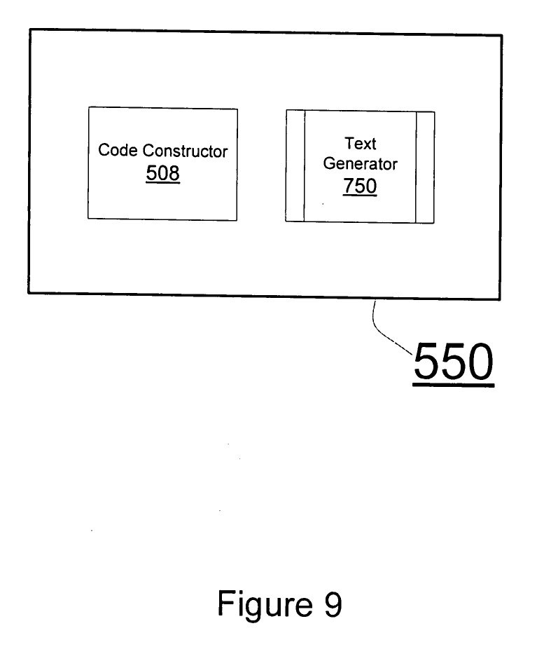

FIG. 9 is a schematic block diagram that indicates important modules for a code generator according to one embodiment of the invention. A code generator 550 has a code constructor 508 and a text generator 450. A code generator 550 processes code exemplars. There are different types of code exemplars, wherein each type corresponds to a type of code construct for a given programming language. Such languages include without limitation C# and Java. The code constructor 508 enables the code generator 550 to map generated source code fragments to appropriate locations within a type of code construct. This is important because different code constructs may have different mappings. The content for a delegate construct, specified in a content exemplar 224, for example, may map to the parameter list of a delegate method. The content for an interface construct may map to the body of the interface declaration. Alternative constructs for alternative languages does not limit present invention. In addition, a code generator 550 has a text generator 450. This is essential because the exemplars used to generate source code within the code construct defined by a code exemplar 220 will always be text exemplars. In other words, the generated source code fragments that map to a code construct (e.g., class, interface, etc.) are text documents generated from special types of text exemplars (i.e., implementation 222 and content 224 exemplars).

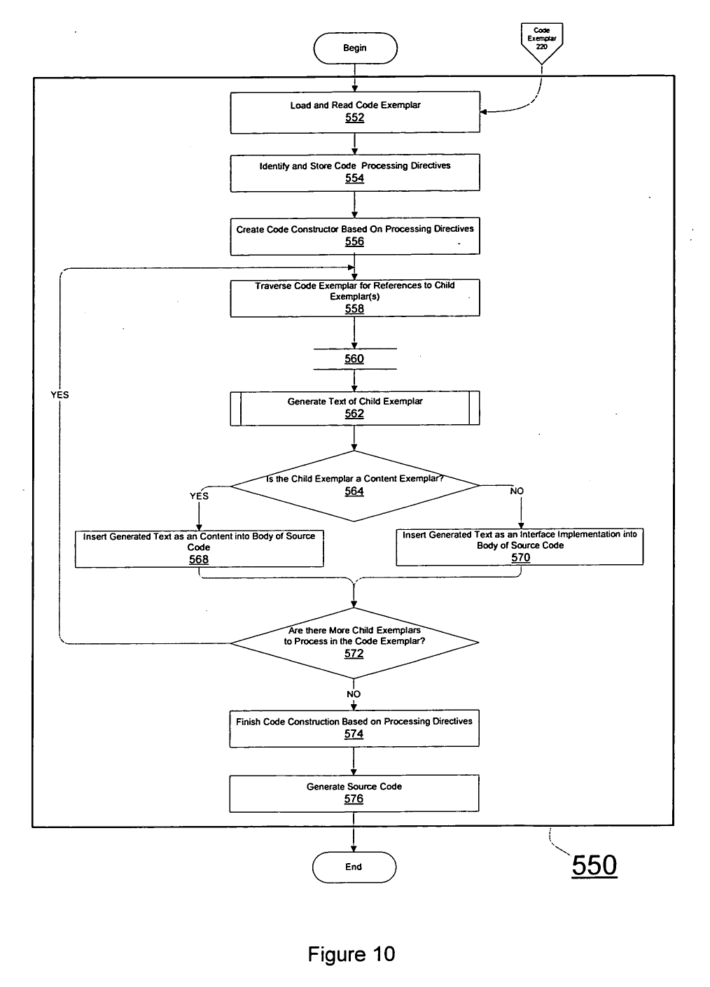

FIG. 10 schematically illustrates a data flow diagram for the code generation process in accordance with a preferred embodiment of the invention. The first step 552 is to load and read a code exemplar 220. Next 554, processing directives are identified and stored. For a code exemplar 220, processing directives may include without limitation naming conventions and code construct type. For example, a processing directive may read
<#@classification=“code” type=“interface”#>

In the next operation 556, a code constructor is created that corresponds to the type of code exemplar being processed, e.g., class, interface, etc. Next 558, the code exemplar is traversed to identify references to child exemplars. Each child may be processed in parallel 560 on its own distinct thread of execution. The next operation 562 is to generate the text of a child exemplar by using the text generation process 400. A check 564 is made to determine if a child exemplar is a content exemplar. If the check 564 evaluates to YES, then the FLOW of operation moves to step 568, wherein the code constructor 508 inserts the generated text as content into the source code of the code construct. In this case, the child is a content exemplar 224. A content exemplar 224 describes content for a given type of code exemplar 220. If the check 564 evaluates to NO, then the FLOW of operation moves to step 570, wherein the code constructor inserts generated text into the body of source code as an interface implementation. In this case, the code exemplar 220 must represent a code construct that supports the implementation of interfaces.

After the generated code has been inserted into the body of source code (step 568 or step 570), a check 572 determines if there are more child exemplars to process. If this check 572 evaluates to YES, then the next step 558 is to traverse the code exemplar 220 and identify further references to childe exemplars. If check 572 evaluates to NO, then the FLOW of operation moves to the next step. During this operation 574, code construction is finished based on processing directives. Processing directives for a code exemplar 224 may include without limitation information pertaining to accessibility, naming conventions, and nested code constructs. Accessibility determines how visible a code construct is to other constructs. For example, a class with “public” accessibility is visible to any other class. A naming convention for a code exemplar 224 determines the name of the resulting code construct and, potentially, the namespace in which the code construct exists. A nested code construct indicates that one code construct is nested within another. An example found in some object-oriented languages occurs when one class is nested within the boundaries of another class. In this case, a nested code construct is processed as a code exemplar whose generated output is placed within the body of the parent code construct. In the next operation 576, the code constructor outputs the constructed source code.

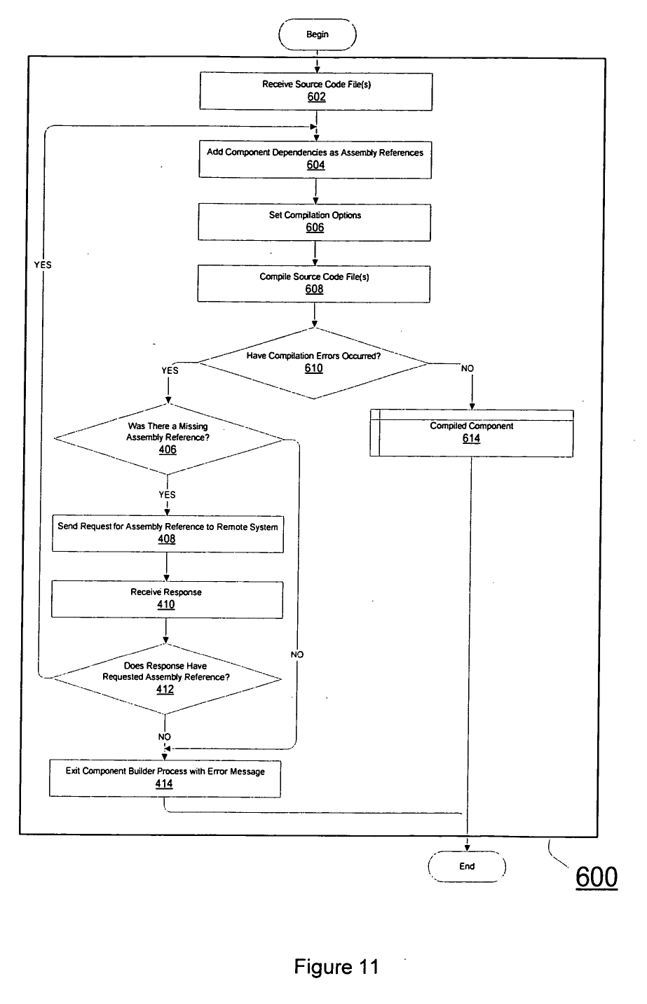

FIG. 11 schematically illustrates a data flow diagram for the component compilation process used in a preferred embodiment of the invention. In the first operation, in-memory source code files 506 are received from the component builder process 400. The next operation 604 builds the list of assembly references needed for compilation. This list may include dependencies on existing components from a domain implementation reuse infrastructure. In a preferred embodiment, this list may also include dependencies on any number of components within the existing solution which have already been compiled as per the component exemplar processing order defined in step 310 in FIG. 5. In the next operation 606, set compilation options including without limitation whether to produce the compiled component in memory or on disk. Next 608, the in-memory source code files 506 are compiled. A check 610 is performed to determine if compilation errors occurred. If the check 610 evaluates to NO, then a compiled component 622 is created and the compilation process 600 ends. If check 610 evaluates to YES, then there compilation errors. A check 612 is conducted to determine if there is a missing assembly reference. If check 612 evaluates to NO, then the FLOW of execution branches to exit the compilation process with an error message 622. If check 612 evaluates to YES, then there is a missing assembly reference. In this case, the next step 616 is to send an asynchronous request to a remote system 150. Next 618, wait and receive the response. A check 620 determines if the response contain the requested assembly reference. If the check 620 evaluates to YES, then the response held the missing assembly reference. The FLOW of operation moves to step 604, wherein a list of assembly references is built. If check 620 evaluates to NO, then a missing assembly reference is not in the response. In this case, FLOW of operation moves to step 622, and the compilation process 600 exits with an error message.

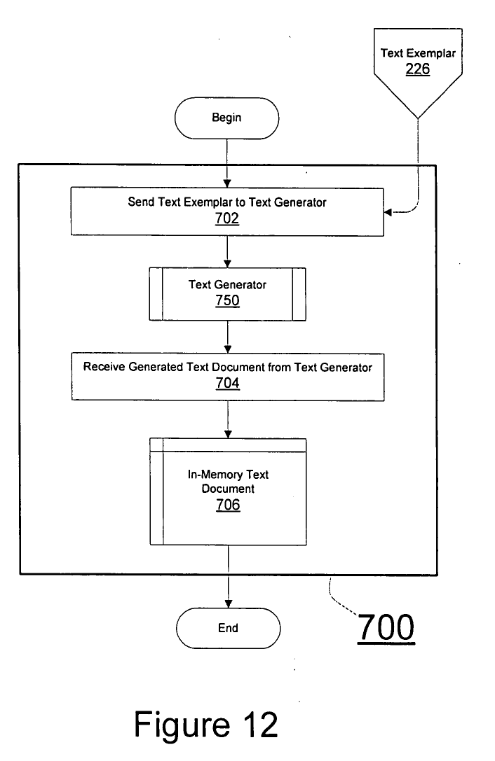

FIG. 12 schematically illustrates an overview of the text generation process used in a preferred embodiment of the present invention. In the text generation process 700, the first step 702 is to send a text exemplar 226 to the text generator 750. After the text generator 750 processes the text exemplar 226, it returns a generated text document which is received in step 704. This in-memory text document 706 is provided as output of the text generation process 700.

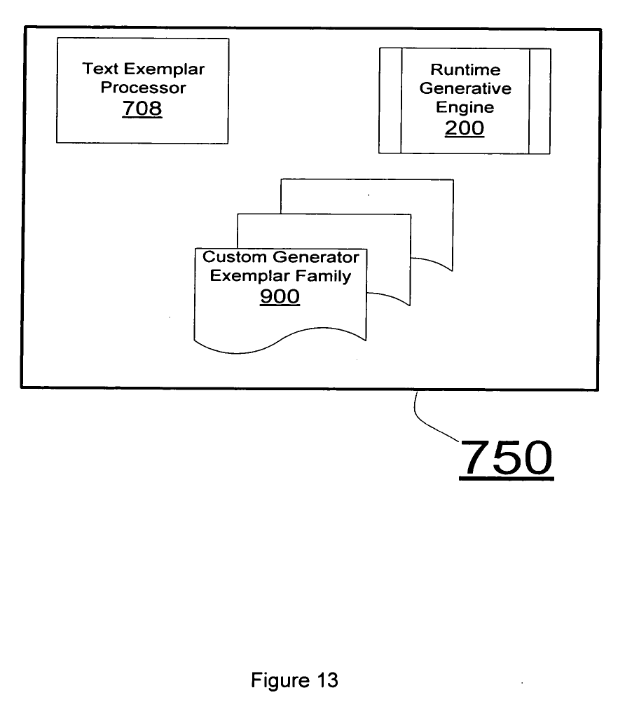

FIG. 13 schematically illustrates an overview of the entities used by a text generator in a preferred embodiment of the invention. A text generator 750 has a text exemplar processor 708, which is used to parse and process various elements of a text exemplar file. In addition, the text exemplar 750 has a static exemplar family. This family 900 represents the basic structure for a software component to be generated by the text generator 750. In a preferred embodiment of the present invention, the software component to be generated represents a custom generator, which will be described in greater detail later. To generate a software component, the text generator 750 uses the runtime generative engine 200.

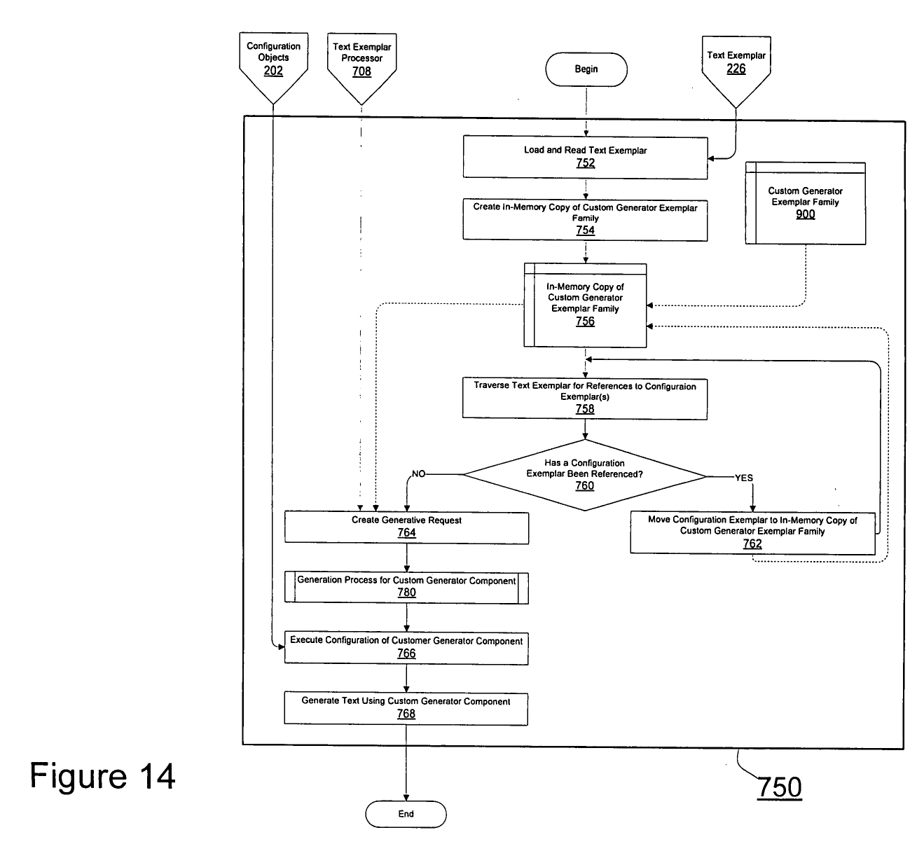

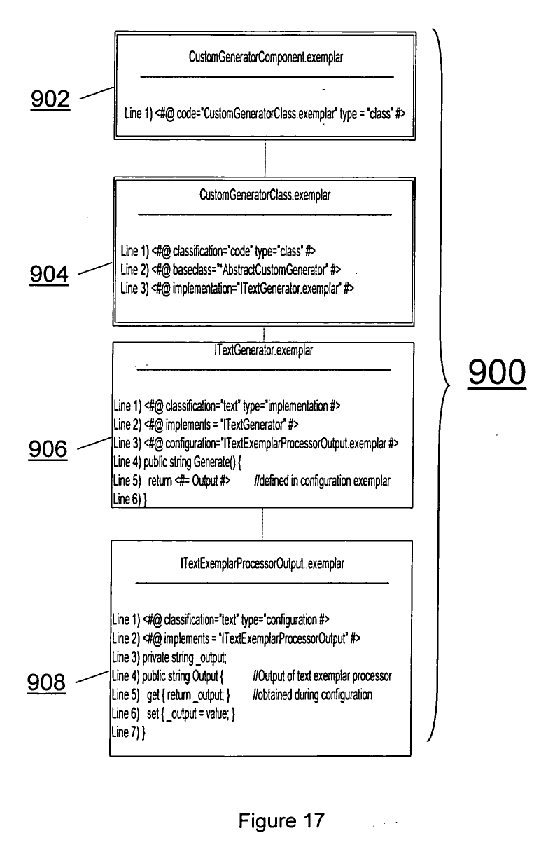

FIG. 14 schematically illustrates a data flow diagram for a text generator according to a preferred embodiment of the present invention. In the first step 752, the text generator 750 loads and reads a text exemplar 202. The next step 754 is to copy the read only custom generator exemplar family 900. This in-memory copy 756 of the custom generator exemplar family will modified by the text generator 750 and used as input into a generative request 160 to the runtime generative engine 200. The next step 758 requires a traversal of the text exemplar 226 to identify references to any configuration exemplar 228. A check 760 is performed to determine if a configuration exemplar 228 has been referenced. If the check 760 evaluates to YES, then a configuration exemplar 228 has been found to be referenced by the text exemplar 226. The FLOW of operation moves to step 762, wherein the text exemplar 226 is modified such that the referenced configuration exemplar is moved to the in-memory copy 756 of the custom generator exemplar family. At the end of this step, the configuration exemplar 228 is no longer a child of the text exemplar 226, but has been transformed into an implementation exemplar 222 which is a child of the in-memory copy 756 of the custom generator class exemplar 900 depicted in FIG. 17. As shown in FIG. 10, this process repeats until all configuration exemplars have been moved from the text exemplar 226 to the in-memory copy of the component exemplar family 756.

If no more configuration exemplars can be processed, then the next step 764 is to create a generative request for the generation of a custom generator component according to a preferred embodiment of the present invention. Configuration objects 208 used to configure the output of the custom generator component are collected together. In addition, the text exemplar processor 708 is added to the collection of configuration objects. As will be later described in detail, the processor 708 in collaboration with other configuration objects configures the custom generator component to generate the proper text. Next, the custom generator component exemplar family 756, which may have implementation exemplar children from the configuration exemplar(s) of the text exemplar 226 being processed, is added to the generative request. No assembly information is explicitly required for creating the generative request, as generating and assembling the custom generator component is straightforward. In one aspect of the invention, default settings are used.

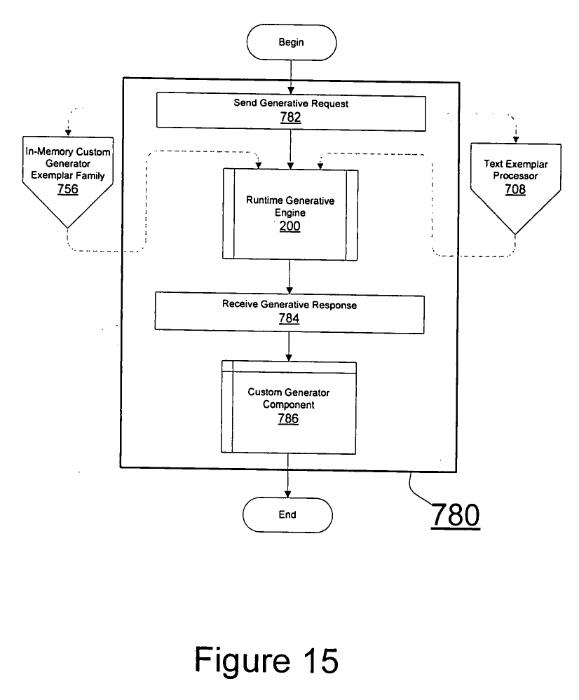

The next step is to generate the custom generator component 780 as depicted in FIG. 15. Once the custom generator component 786 has been produced, the next step 766 is to execute the configuration of the custom generator component 786. In a preferred embodiment, the visitor design pattern is used to enable external configuration objects “visit” and configure the custom generator component 786. Configuration occurs through interfaces defined by the configuration exemplar(s) that became implementation exemplars of the in-memory copy 756 of the custom generator exemplar family in step 762. The final step 768 is to generate text with the custom generator component 786.

FIG. 15 a schematic illustration of the runtime generation process of a custom generator component is shown in accordance with a preferred embodiment of the present invention. In the first step 782 a generative request is sent to the runtime generative engine 200. This generative request is comprised by the in-memory custom generator exemplar family 756 (which has been modified to include configuration exemplars from step 762 in FIG. 14) and the text exemplar processor 708, which is provided as a configuration object to configure the generated source code representing the custom generator component. The runtime generative engine 200 processes the generative request. During this process, according to the preferred embodiment of the invention, the text exemplar processor 708 is called upon, as a configuration object, to configure the generation process. At this point, the text exemplar processor 708 parses and processes the body of the text exemplar 226. The output of this is placed within the custom generator component. In step 784, a generative response is received, resulting in a custom generator component 786 in memory.

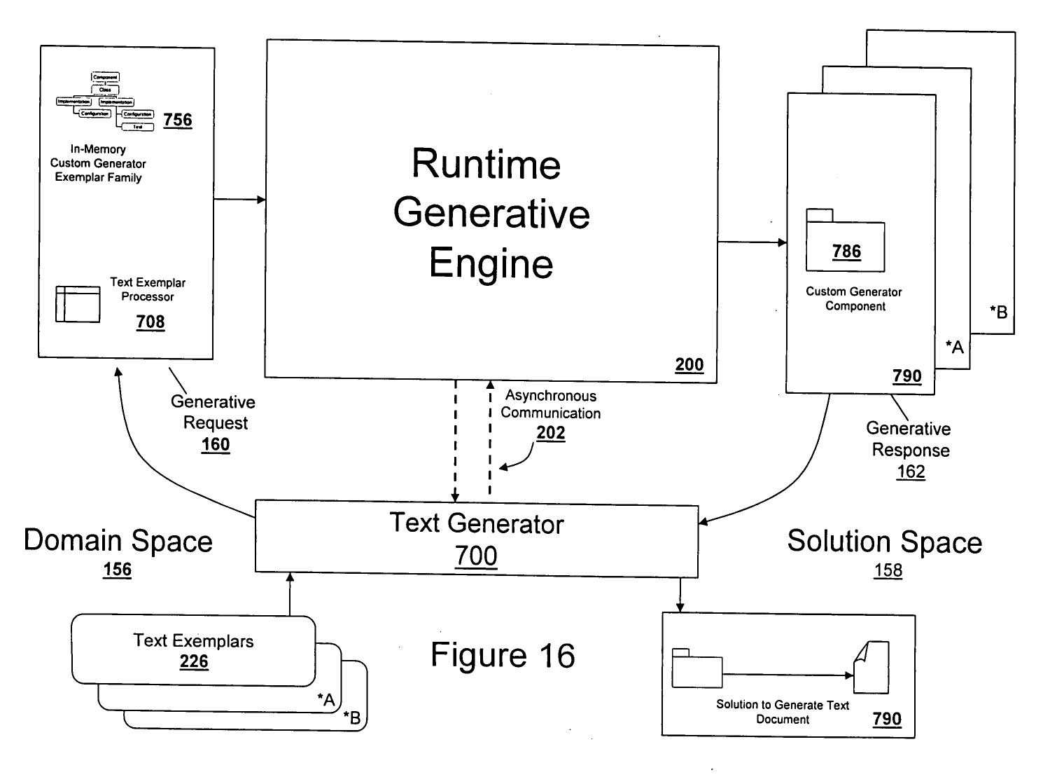

FIG. 16 schematically illustrates the process of text generation within a runtime generative software development environment in accordance with the present invention. This diagram is analogous to the runtime generative software development environment depicted in FIG. 2. The text generator 750 takes over the duties of the generative assembly line manager 150. In the case, the domain space 156 is represented by the problem of text generation. The solution space is represented by concrete text generation solutions used to meet the needs of specified configuration requirements. The text generator 750 detects changes to configuration requirements when it receives a text exemplar 226 to be processed. To solve this problem, the text generator manages the assembly process for a custom generator 786 which, in turn, will generate output text documents 706. The generative request 162 of the text generator 750 is comprised of a text exemplar processor 708, used to configure the generation of the custom generator, and a custom generator exemplar family 756. The output of the runtime generative engine 200 is a generative response 162 with a custom generator component 786, which is customized to solve domain-specific configuration requirements. Immediately, the text generator 750 deploys the custom generator component as a solution 790 to generates text. In a preferred embodiment of the present invention, the invention employs itself at runtime to solve the problem of runtime text generation.

FIG. 17 schematically illustrates the family of exemplars for the custom generator used to generate a text document in a preferred embodiment of the invention. For each text exemplar 226 processed, the text generator 750 makes a copy 756, in memory, of this exemplar family 900. The custom generator exemplar family 900 has a parent component exemplar 902 with the file name “CustomGeneratorComponent.exemplar”. The custom generator component exemplar 902 defines the basic structure of the custom generator component 786.

In an exemplar, everything between the “<#” and “#>” brackets define a block of exemplar code to be processed. Everything outside the “<#” and “#>” brackets is treated as a literal string and left untouched during the generation process. Content between “<#@” and “#>” brackets define processing directives used to inform the generation process. Items within “<#” and “#>” brackets are processed and compiled to be used as programming logic within a custom generator class. Line 1 of the component exemplar file 902 declares a processing directive that classifies the exemplar as a component exemplar. Line 2 of the file has a processing directive that references a code exemplar with a type of “class” and a file name of “CustomGeneratorClass.exemplar”.

This custom generator class exemplar 904 defines, in part, the structure of the class generated for the custom generator component 786. As described in step 762 in FIG. 14, configuration exemplars may be added to modify the structure of the generated class. Line 1 of the code exemplar file 904 indicates the classification and type of exemplar, in this case a code exemplar 220 with a class type. Line 2 indicates the generated class should inherit from a base class with a type of “AbstractCustomGenerator”. The AbstractCustomGenerator class has functionality common to all custom generators 786 used by the text generator 750. That is, the AbstractCustomGenerator base class is part of the reuse infrastructure of the text generation domain space 156. Line 3 of the code exemplar file 904 references an implementation exemplar with a file name of “ITextGenerator.exemplar” 906. The content of the implementation exemplar file 906 defines an interface which will be implemented by the generated custom generator class. Line 1 of the “ITextGenerator.exemplar” file 906 indicates the exemplar is classified as a text exemplar with an implementation type. Line 2 of the file 906 indicates the implementation exemplar will implement an interface of type “ITextGenerator”. The definition of the ITextGenerator interface is provided as follows.

public interface ITextGenerator
{
string Generate( );
}

This ITextGenerator interface defines a contract such that any class that implements the ITextGenerator interface must have a Generate ( ) method that, after execution, returns a string. In this way, other components that know of the interface but perhaps not the class behind it can use the interface by agreeing to the terms of the contract. Lines 4-6 of the implementation exemplar file 906 provide the code fragment used to implement the ITextGenerator interface. In line 4, a Generate( ) method with a return type of string is declared, thus satisfying the contract with the ITextGenerator interface. The Generate( ) method is used by the custom generator component to generate a configured text document. Line 5 reads as follows.
<#=Output#>;

An expression between “<#=” and “#>” brackets evaluates to a string value and is placed in-line with the text. In line 5 of the file 906, it follows that the “Output” variable will be evaluated as a string. However, the “Output” variable is not defined within the implementation exemplar file 906. Instead, it is defined within the configuration exemplar file 908 referenced in line 3 of the exemplar file 906. The “Output” variable is used to configure the output of the Generate( ) method of the custom generator. As such, it represents a variation point between one custom exemplar and another. As shown in line 2 of the configuration exemplar file 908, the configuration exemplar is used to implement the ITextExemplarProcessorOutput interface. The ITextExemplarProcessorOutput interface is provided as follows.

public interface ITextExemplarProcessorOutput
{
string Output { get; set; }
}

This interface has an “Output” property with associated get and set behavior. Lines 4-7 of the configuration exemplar file 908 show the exemplar contains code necessary to satisfy the contract of the interface. When the implementation exemplar file 906 is processed by the text generator 750, it will have its own custom generator created that, in turn, will implement the ITextExemplarProcessorOutput interface. This interface will be used by the text exemplar processor 708 to provide parsed and processed content which will be inserted as the code body for the Generate( ) method in line 5 of the implementation exemplar 906.

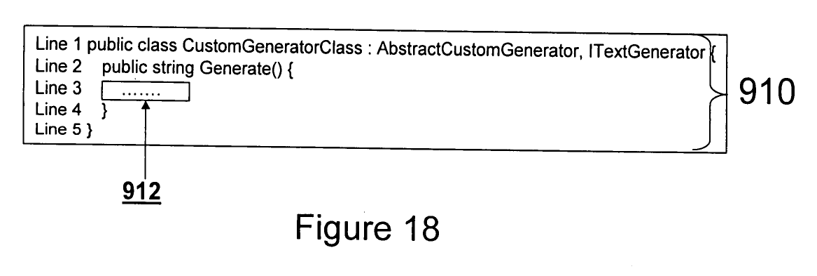

FIG. 18 schematically illustrates an example of the source code generated for a custom generator according to a preferred embodiment of the present invention. By default, if a class name is not declared in a processing directive of a code exemplar 220, the name of the class will correspond to the name of the exemplar file. In this case, the class name becomes “CustomGeneratorClass”. Line 1 shows the class, inherits from the AbstractCustomGenerator base class and implements the ITextGenerator interface. Line 2 declares the Generate( ) method. Line 3 indicates where the generated content 912 of the Generate( ) method would be inserted.

The above specification, examples and data provide a complete description of the manufacture and use of the composition of the invention. Since many embodiments of the invention can be made without departing from the spirit and scope of the invention, the invention resides in the claims hereinafter appended.

I claim:

1. A system for generating software components during runtime of a code generator, said system comprising:
predefined inputs set prior to runtime comprising exemplars and configuration objects, said exemplars being a family of document written in coding language that is logically interrelated to control a generative process, said exemplars representing software objects in terms of said configuration objects;
a first level generator for generating a respective second level generator for each said exemplar, said second level generator for processing said respective exemplar; and
output in the form of text produced from processing each exemplar using its respective second level generator, said text being either in the form of a text document or a compliable source code file.

2. The system of claim 1, wherein said exemplars are selected from the group consisting of text exemplars, component exemplars, class exemplars, interface exemplars, member exemplars, solution exemplars and implementation exemplars.

3. The system of claim 1, further comprising a compiler for compiling output generated by one of said second level generators after processing its respective exemplar.

4. The system of claim 3, further comprising a software component generated from executed complied output from one or more processed exemplars which is a runtime input comprising one or more runtime exemplars, and wherein said first level generator generates a respective second level generator for each said runtime exemplar, and said second level generator for processing said respective runtime exemplar.

5. The system of claim 3, wherein said compiler produces a runtime software component which is executable during runtime.

6. The system of claim 1, further comprising a text document generated from processed exemplars, said text document is a runtime input comprising one or more runtime exemplars, and wherein said first level generator generates a respective second level generator for each said runtime exemplar, and said second level generator for processing said respective runtime exemplar.

7. The system of claim 1, wherein at least one exemplar comprises a child exemplar.

8. The system of claim 6, wherein said predefined inputs define an internal, self-contained problem space and solution space in which said first level generator and said second level generator function when processing said exemplars.

9. The system of claim 8, wherein first level generator produces runtime queries external to said predefined inputs and/or receives external runtime inputs to configure said first level generator.

10. The system of claim 8, wherein said queries are in the form of asynchronous communication.

11. The system of claim 1, wherein one or more exemplars are processed by its respective second level generator to produce runtime configuration data.

12. The system of claim 1, wherein said text exemplar comprises at least configuration exemplar which defines the implementation of a domain-specific programmatic interface to configure said text exemplar for use in defining said domain specification.

13. The system of claim 1, wherein said component exemplar defines the structure of a software component produced from one or more processed exemplars, in terms of one or more class exemplars and interface interfaces which comprises said software component.

14. The system of claim 13, wherein said class exemplar is a text exemplar which defines the structure of an individual class and said interface exemplar is a text exemplar which defines the structure for an individual interface of said programmatic interface.

15. The system of claim 1, wherein said interface exemplar comprises a member exemplar which is a text exemplar defining members of a class, and methods of a class or interface.

16. The system of claim 1, wherein said implementation exemplar is a text exemplar the defines the implementation of an interface for a class.

17. The system of claim 1, further comprising a programmatic interface between the code generator and an external system which comprises part of the dynamic instructions.

18. The system of claim 1, wherein present input further comprises assembly information referenced by at least one exemplar.

19. A method for generating software components comprising:
generating one or more component exemplars, each said component exemplar in terms of logic, related to a family of class exemplars corresponding to a set of dynamic instructions defining a problem space and/or interface exemplars for implementing said class in a generative engine;
generating domain-specific information;
passing said component exemplars and said domain-specific information into a runtime generative engine; and
processing said component exemplars instantiate said class exemplars, which, with said interface exemplars are used to generate a software component.

20. A method for generating software components, said method comprising:
creating predefined inputs set prior to runtime comprising one or more exemplars, and configuration objects, said exemplars being a family of document written in coding language that is logically interrelated to control a generative process, said exemplars representing software objects in terms of said configuration objects;
generating a respective generator for each said exemplar, to process said respective exemplar; and
processing said respective exemplar using said respective generator to produce either a source code file or text document.

21. The method of claim 20, wherein said exemplars are selected from the group consisting of text exemplars, component exemplars, class exemplars, interface exemplars, member exemplars, solution exemplars and implementation exemplars.

22. The method of claim 20, further comprising compiling the source code file to produce an executable software component.

23. The method of claim 20, further comprising executing said software component during runtime of generating a respective generator and processing said respective exemplars.

24. The method of claim 20, wherein said software component comprises a runtime generated exemplar and said method further comprises:
generating a respective generator for said runtime exemplar, and processing said runtime exemplar using said respective generator to produce output in the form of a text documents or compliable source code.

25. The method of claim 20, further comprising generating a text document generator to process a runtime exemplar present in said text documents and processing said runtime exemplar using the generator to process said runtime exemplar.

26. The method of claim 20, wherein at least one exemplar comprises a child exemplar.
